(19) United States
(12) Patent Application Publication
(10) Pub. No.: US 2006/0172269 A1
(43) Pub. Date: Aug. 3, 2006

(54) Method of teaching behavior modification relating to sanitation

(76) Inventors: Anne Langone, New York, NY (US); Jeffrey Tomaka, New York, NY (US); Christopher J. Varley, Islip, NY (US); Charles M. Johnson, Bloomfield, NJ (US); Bryan Lee, Norwood, NJ (US)

Correspondence Address: KATTEN MUCHIN ROSENMAN LLP, 525 WEST MONROE STREET, CHICAGO, IL, 60661-3693, US

(21) Appl. No.: 11/049,782

(22) Filed: Feb. 3, 2005

(51) Int. Cl. G09B 19/00

(52) U.S. Cl. 434/238

(57) ABSTRACT

A method of modifying behavior is disclosed which can be implemented by one or more behavior mechanisms in order to modify behavior of target subjects, for example, in industries, such as the health care and food industries, in which sanitation of the target subject is essential in order to promote healthier and more sanitary working environments. In accordance with the present invention, various behavior modification mechanisms are provided for modifying behavior of target subjects with respect to sanitation to promote a healthier and safer environment for both the target subject and those in contact with the target subject and the target environment. These behavior modification mechanisms are useful in various industries including the health care and food industries. These behavior modification mechanisms may include devices as well as iconography, configured to promote behavior modification with respect to sanitation. The devices may include portable devices, such as, a wearable antibacterial gel and/or towelette dispenser and a medical caddy formed from an antibacterial material for environmentally safe transport of materials, which optionally carries an antibacterial gel and/or towelette dispenser and stationary devices, such as, a wall or table mounted dispenser for dispensing antibacterial gel and/or towelettes and a wall or table mounted antibacterial gel filling station for filling portable devices. The behavior modification mechanisms may also include a device for puncturing plastic wrap used for food seals.

### BACKGROUND OF THE INVENTION

1. Field of the Invention

The present invention relates to a method of teaching behavior modification to improve personal sanitation habits and more particularly to a method of teaching a behavior by exposing target subjects to one or more behavior modification mechanisms designed to promote healthier and more sanitary, working environments, particularly in the health care industry.

2. Description of the Prior Art

Sanitation is essential in many different industries, such as the food industry, the cosmetic industry and the health care industry. In the healthcare industry, for example, healthcare professionals must learn to properly sanitize their person and their environment pre, during, and post contact with or exposure to patients to minimize the risk of becoming a host to germs and transferring those germs from patient to patient. Many sanitation techniques are known for minimizing such risks. Examples of such sanitation techniques include proper hand sanitation techniques. Unfortunately, not all healthcare professionals strictly adhere to such techniques, resulting in inadequate levels of sanitation, which, in turn, increases the risk of the spread of germs and thus jeopardizes their own safety as well as the safety of their patients. Also, it is difficult to police adherence to such sanitation techniques. Thus, a need exists for a method of teaching behavior modification which encourages adherence to sanitation techniques by exposing target subjects to one or more mechanisms designed to promote healthier and more sanitary working environments.

Many techniques are known for teaching behavior modification in general. Such techniques can be classified as either passive or active. Examples of known active behavioral modification techniques are disclosed in U.S. Pat. Nos. : 5,207,580; 5,388,043; 5,967,789; 6,039,688; U.S. Patent Application Publication Nos. US 2004/0067475 A1; US 2004/0247748 A1; and US 2004/0249250 A1; International Patent Application Publication Nos. : WO 00/75748 A2 and WO 2004/015606 A1 and European Patent Application no. 0 427 875 A1. In general, the active behavior modification techniques taught in those publications are interactive and generally require feedback from the target subject, for example, over a computer network. As such, those techniques are not suitable for many applications. Such techniques would be virtually ineffective to modify the behavior of health care professionals, for example, with respect to sanitation.

U.S. Patent Application Publication No. US 2001/0006206 A1 discloses a device for promoting and detecting compliance with hand sanitation techniques, suitable for use in the health care and food industry. The '206 publication discloses a dispenser for dispensing towelettes that have been pre-treated with an antibacterial solution. The dispenser includes a sensor for sensing badges worn by the target subjects in order to keep track of the target subjects and the frequency which they use the dispenser. By monitoring use of the dispenser, increased use of the dispenser is encouraged, thus encouraging behavior modification of the target subjects with respect to hand sanitation. Although the towelette dispenser promotes improved sanitation by the target subjects, the dispenser is stationary. As such, it is not suitable for many applications.

As mentioned above, passive behavior modification techniques are also known. Examples of such passive behavior modification techniques are disclosed in U.S. Pat. Nos. : 6,325,222; 6,602,075 and RE 37,535 and U.S. Patent Publication No. US 2003/0134259 A1. U.S. Pat. Nos. : 6,325,222 and RE 37,535 disclose a device for improving behavior of a target subject with respect to taking daily medications. These patents disclose a tooth brush holder formed with a holder for a medicine bottle. By integrating the medicine bottle with a daily routine, such as brushing, the subject is reminded to take the daily medication in the medicine bottle. Although the passive behavior modification technique disclosed in the '222 and '535 patents is effective in modifying behavior in target subjects with respect to taking daily medications, that technique is not applicable to modify other types of behavior.

U.S. Pat. No. 6,602,075 and U.S. Patent Application Publication No. US 2003/0134259 A1 disclose yet another passive behavior modification technique. The behavior modification techniques disclosed in these publications relate to behavior modification of a target subject with respect to a person, animal or object by identifying a behavior to be modified, modeling that behavior, exposing the target subject to the perspective of the person, animal or object and implementing an appropriate behavioral modification mechanism to modify the behavior. The '075 patent relates to a behavior modification technique for teaching duck hunting to a target subject. In order to enhance the ability of the target subject to appreciate the subtleties of duck hunting, the behavioral modification mechanism is configured to expose the target subject to duck behavior so that the target subject is exposed to the perspective of the animal. In this case, one behavior modification mechanism is a training video on duck hunting in various hunting environments. The '259 publication, is a continuation of the '075 patent.

Unfortunately, the passive behavior modification mechanisms taught by the '259 publication and the '075 patent, as well the various other publications discussed above, are behavior specific and are not extendable to modifying other behaviors. Thus, there is a need for a behavior modification mechanism that can be used to improve sanitation habits of target subjects in applications where sensing and recording compliance with proper sanitation behavior is not possible or practical.

### SUMMARY OF THE INVENTION

Briefly, the present invention relates to a method for modifying the behavior of target subjects, for example, in industries, such as the health care, cosmetic, retail and food industries, in which sanitation of the target subject is essential in order to promote healthier and more sanitary working environments. In accordance with the present invention, the method is implemented by one or more behavior modification mechanisms configured to promote a healthier and safer environment for both the target subject and those in contact with the target subject and the target environment. These behavior modification mechanisms are useful in various industries including the health care and food industries. These behavior modification mechanisms may include devices as well as iconography, configured to promote behavior modification with respect to sanitation. The devices may include portable devices, such as, an antibacterial gel and/or towelette dispenser and a medical caddy formed from an antibacterial material for environmentally safe transport of materials, and stationary devices, such as, a wall or table mounted dispenser for dispensing antibacterial gel and/or towelettes and a wall or table mounted antibacterial gel filling station for filling portable devices. The behavior modification mechanisms may also include a device for puncturing plastic wrap used for food seals.

### BRIEF DESCRIPTION OF THE DRAWINGS

These and other advantages of the present invention are readily understood with reference to the following specification and attached drawing wherein:

FIGS. 1A and 1B are rear and front perspective views, respectively, of a behavior modification mechanism in accordance with the present invention, configured as a portable antibacterial gel dispenser, shown with a dispensing nozzle and slider button in a normal position.

FIG. 1C is similar to FIGS. 1A and 1B, but shown with the dispensing nozzle and slider button in a dispensing position.

FIG. 1D is an exploded perspective view of the antibacterial gel dispenser illustrated in FIG. 1A.

FIG. 1E is a perspective view of the portable antibacterial gel dispenser, shown in FIG. 1A, illustrating the internal components in a relaxed or normal position.

FIG. 1F is similar to FIG. 1E but shown in an intermediate position in which the torsion spring is compressed and the extended nozzle is rotated to a dispense position.

FIG. 1G is similar to FIG. 1E but shown in a position in which the nozzle and pump are fully depressed causing liquid to flow.

FIG. 1H is a perspective view of the antibacterial gel dispenser illustrated in FIG. 1A, shown with a belt clip.

FIG. 1I is a perspective view of the antibacterial gel dispenser illustrated in FIG. 1H, illustrating an exemplary method for attaching the belt clip to the antibacterial gel dispenser.

FIG. 2A is a perspective view of another behavior modification mechanism in accordance with the present invention, configured as an antibacterial medical caddy.

FIG. 2B is a perspective view of the handle assembly which forms a part of the antibacterial medical caddy, illustrated in FIG. 2A.

FIG. 2C is a perspective view of the medical caddy illustrated in FIG. 2A, shown with the handle assembly removed.

FIG. 2D is an exploded perspective view of the handle assembly illustrated in FIG. 2B.

FIG. 3A is a perspective view of another behavior modification mechanism in accordance with the present invention, configured as a combination dispensing unit for dispensing antibacterial towelettes and gel.

FIG. 3B is similar to FIG. 3A but illustrating a rear view of the combination dispensing unit illustrated in FIG. 3A.

FIG. 3C is an exploded perspective view of the combination antibacterial dispensing unit illustrated in FIG. 3A.

FIG. 3D is a side perspective view of the combination dispensing unit illustrated in FIG. 3A, shown with the towelette refill door open, illustrating refilling of the towelettes.

FIG. 4A is a perspective view of another behavior modification mechanism in accordance with the present invention, configured as an antibacterial gel filling station.

FIG. 4B is similar to FIG. 4B but illustrating the rear view.

FIG. 4C is an exploded perspective view of the antibacterial gel filling station illustrated in FIG. 4A.

FIG. 5 is a perspective view of another behavior modification mechanism in accordance with the present invention, configured as antibacterial recognizable iconography.

FIGS. 6A and 6B are perspective views of another behavior modification mechanism in accordance with the present invention, configured as a portable device for piercing plastic wrap used to seal food products.

FIG. 6C is a perspective view of the device illustrated in FIGS. 6A and 6B.

### DETAILED DESCRIPTION

The present invention relates to a method for modifying behavior in order to promote sanitation in various industries, such as the healthcare, cosmetic, retail and food industries. In the healthcare industry, for example, healthcare professionals and/or health care non-professionals (“healthcare personnel”) are exposed to one or more behavior modification mechanisms which promote proper sanitation of the target subject and their environment during all stages of patient care (i.e. pre, during, and post patient care or patient visits). In one aspect of the invention, the method for modifying behavior is implemented by behavior modification mechanisms configured to promote proper hand washing to minimize healthcare personnel from becoming a host to germs and transferring germs from patient to patient and patient to other healthcare and non-healthcare personnel. These behavior medication mechanisms are configured as both portable and stationary devices. One or more of these behavior modification mechanisms may be optionally used with iconography configured to promote hand sanitation. The behavior modification mechanisms mentioned above, are applicable to various industries other than the healthcare industry, such as the cosmetic and the food industry. In accordance with another aspect of the invention, another behavior modification mechanism is provided for the healthcare industry in the form of a medical caddy for carrying live samples and cultures from patients in a bacterially safe container which minimizes the transfer of germs from the patient to surfaces and to other personnel. The medical caddy in accordance with the present invention may also be configured to carry an antibacterial gel and/or towelette dispenser in order to promote hand sanitation. Lastly, the behavior modification mechanisms may also include a device for puncturing plastic wrap used for food seals. Such a device can be used in virtually any industry that serves pre-prepared foods that are sealed in plastic wrap and heated in a microwave oven, such as the airline industry, schools, healthcare industry, and others. This device may be configured with antibacterial components for safely and cleanly puncturing food seals thus promoting proper food sanitation. All of the above mentioned behavior modification mechanisms are used to promote various aspects of sanitation. In accordance with an important aspect of the invention, each of the behavior medication mechanisms in accordance with the present invention may be provided to the personnel for use without further instruction or interaction.

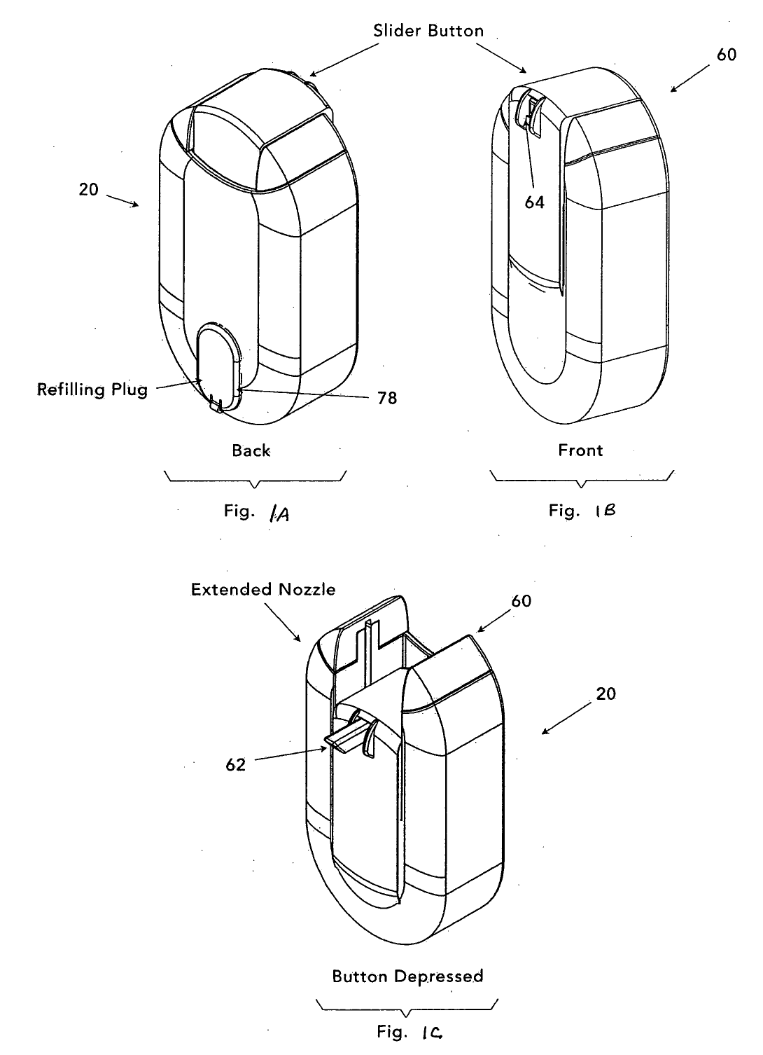

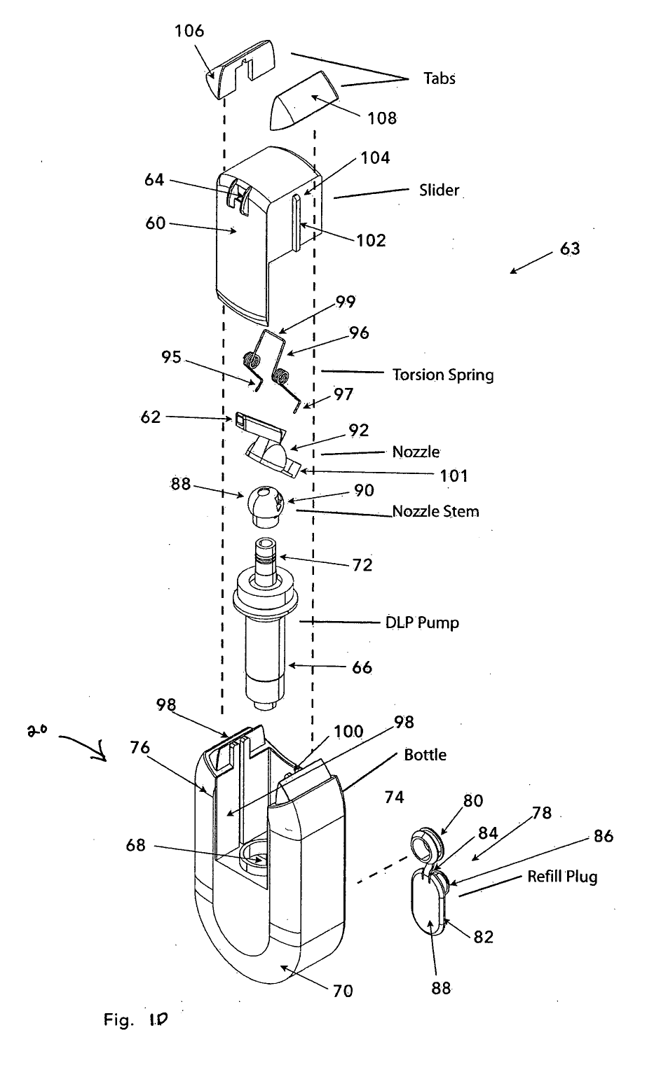

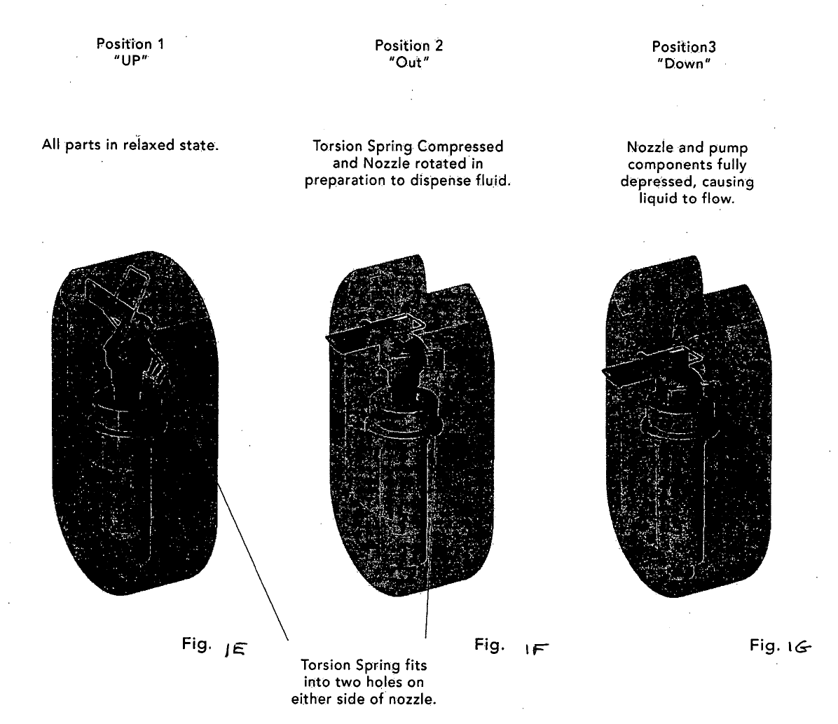

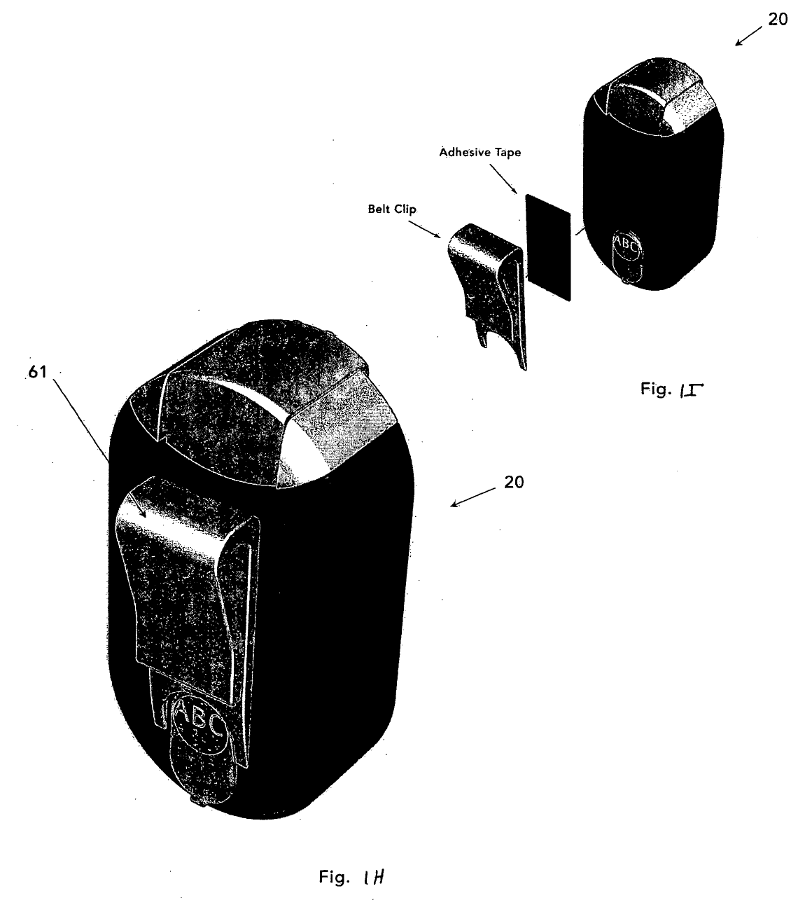

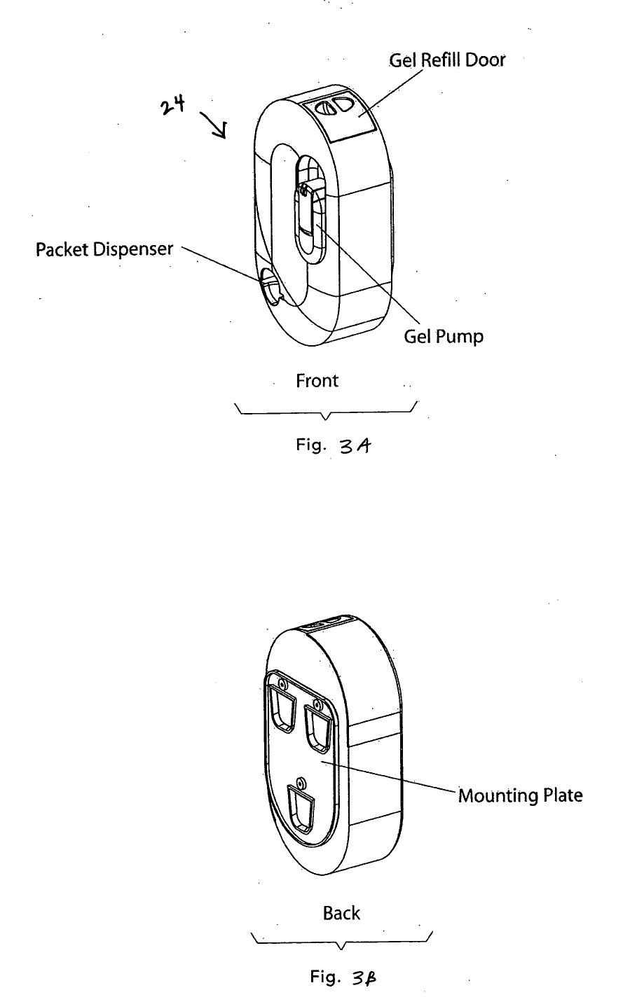

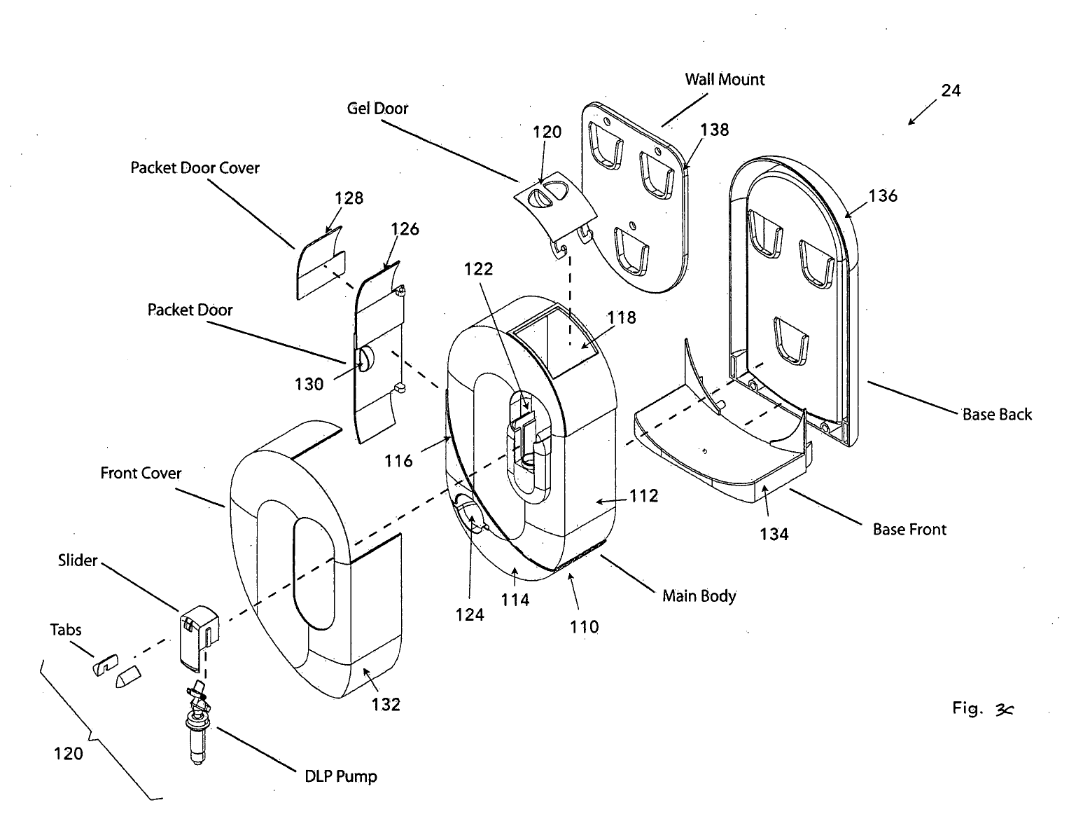

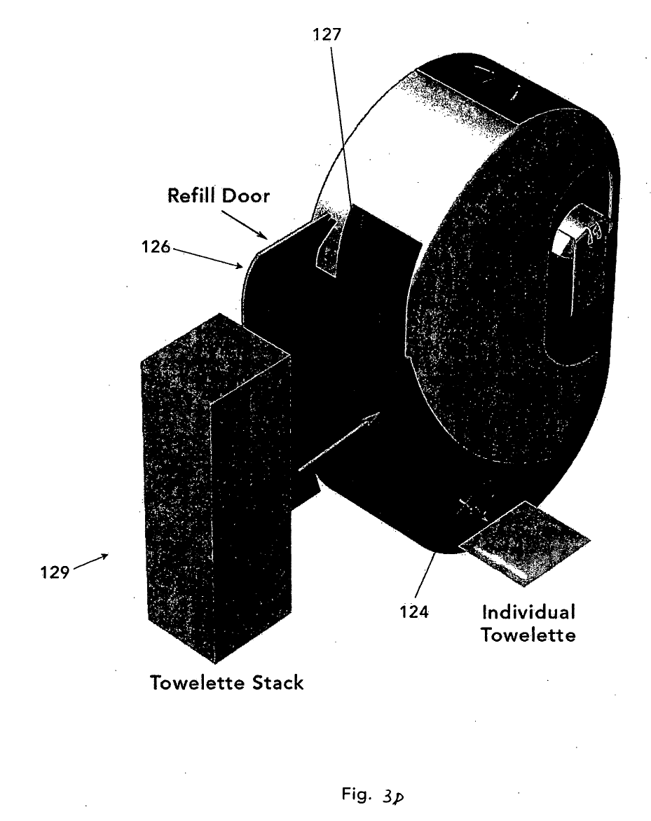

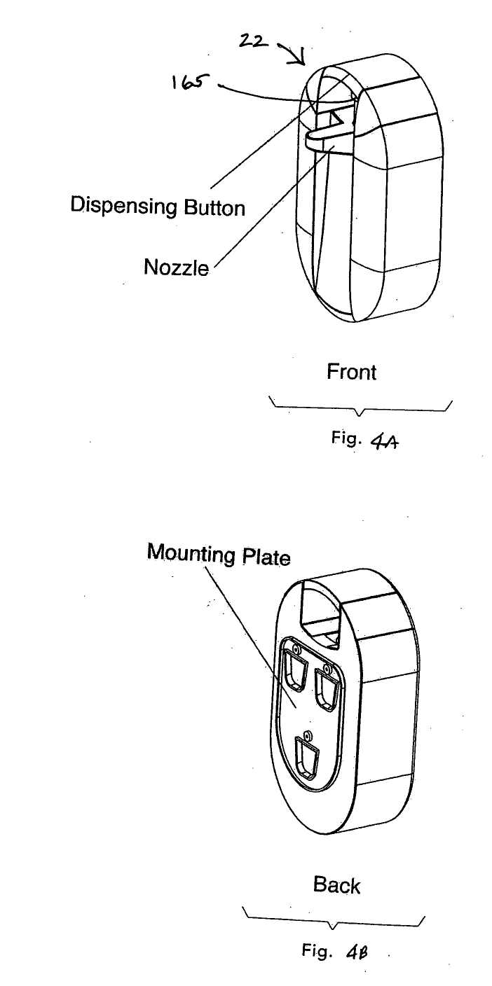

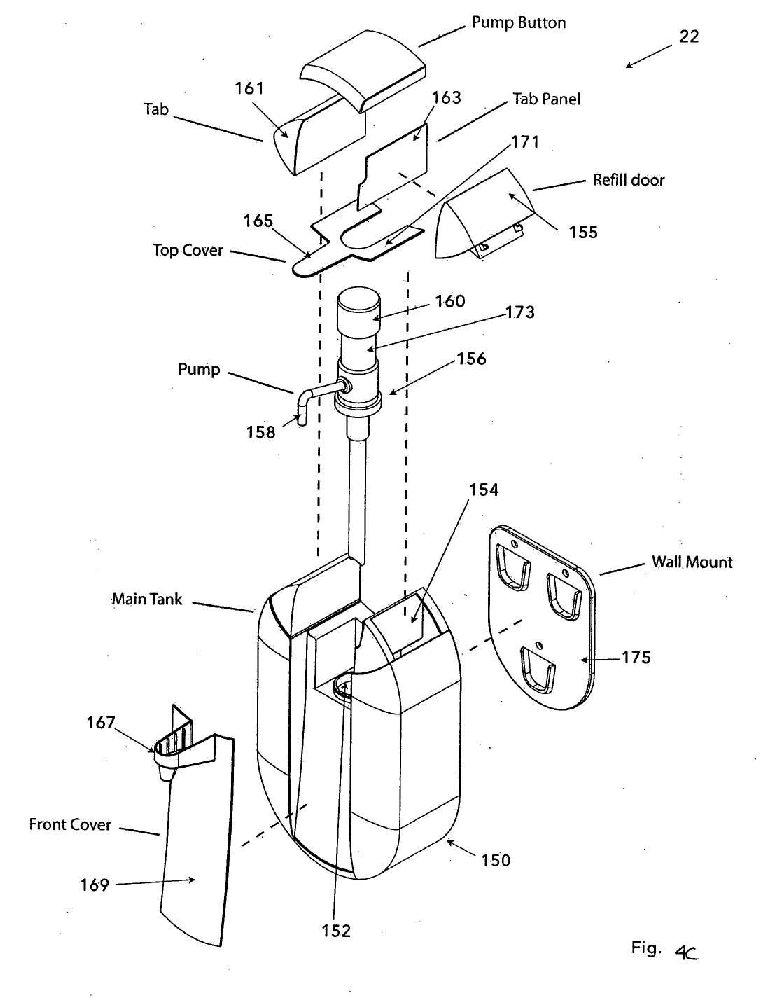

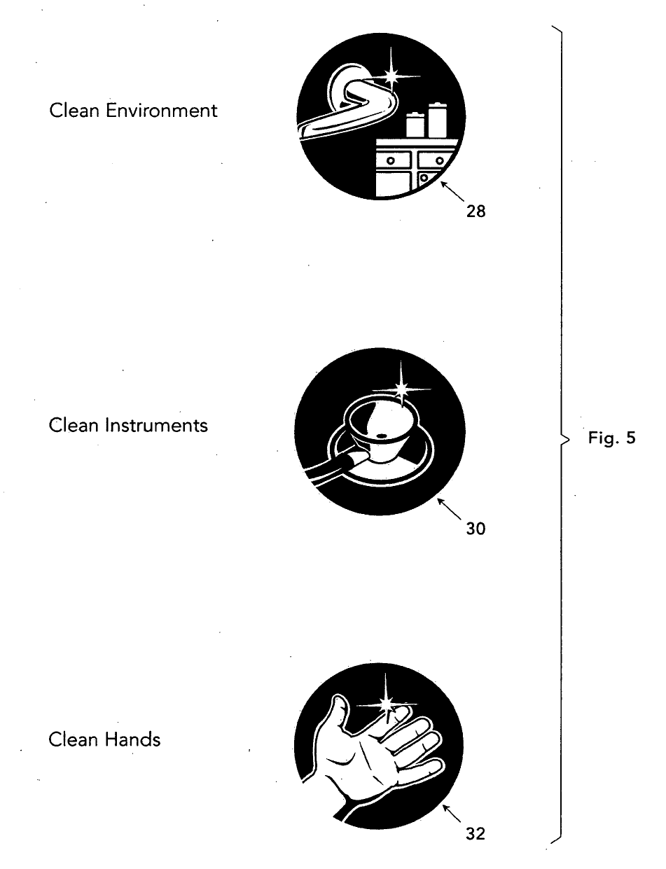

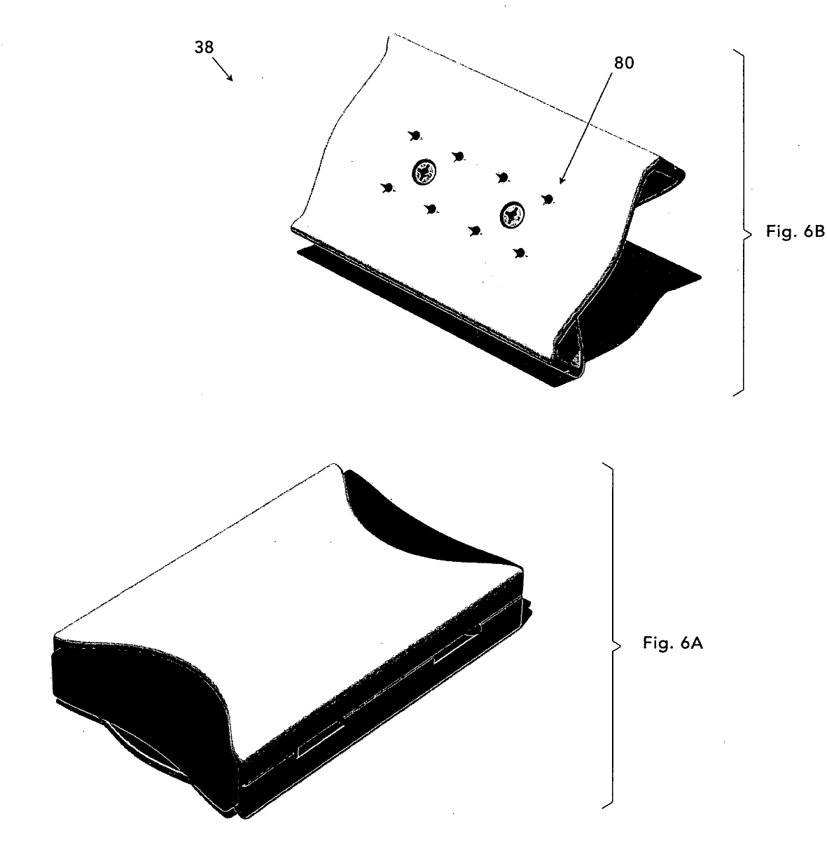

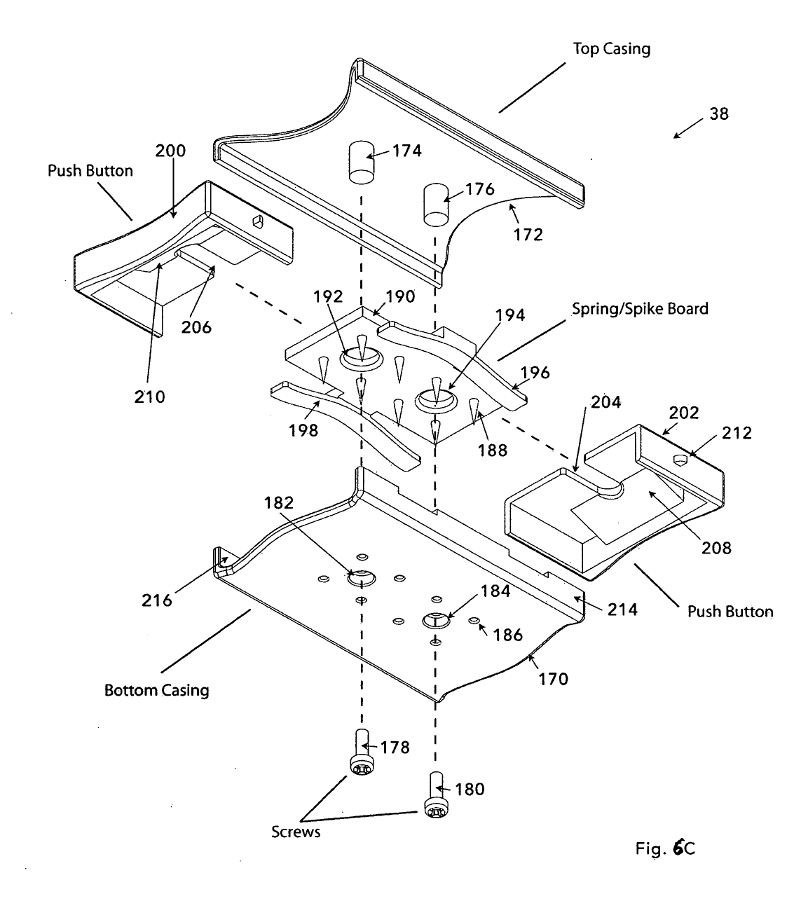

Although many of the various behavior mechanisms are described in terms of the healthcare industry, these behavior mechanisms are also useful in other industries. For example, the portable antibacterial gel dispenser (FIGS. 1A-1I), combination antibacterial gel and towelette dispenser (FIGS. 3A-3D) and the antibacterial gel filling station (FIGS. 4A-4C), as well as the iconography (FIG. 5) are clearly useful in other industries, such as the cosmetic, retail and food industries. The sanitary device (FIGS. 6A-6C) for punching holes in plastic wrap used to seal pre-prepared foods is useful in virtually any industry that serves such food.

Each of the behavior modification mechanisms in accordance with the present invention are passive behavior modification mechanisms and are configured to change behavior by providing increased awareness of sanitation to target subjects in target environments. For example, the portable antibacterial gel dispenser in accordance with the present invention, illustrated in FIGS. 1A-1I, generally identified with the reference numeral 20, may be provided with a belt clip to allow it to be worn by healthcare personnel. By providing a wearable behavior modification mechanism, such as the wearing the portable antibacterial gel dispenser 20, healthcare or other personnel are provided with an improved awareness of the need for hand sanitation. Such improved awareness leads to improved hand sanitation behavior since the portable antibacterial gel dispenser will be a constant reminder to target subjects to wash their hands. Indeed, by facilitating proper sanitation by providing healthcare personnel with a wearable antibacterial gel and/or towelette dispenser, healthcare personnel are encouraged to properly sanitize their hands in all aspects of their working environment including between patient visits, thereby increasing the efficacy of improved hand sanitation behavior, thus reducing the risk of healthcare personnel becoming a host and transferring germs from patient to patient.

In order to further promote and facilitate behavior modification with respect to hand sanitation, an antibacterial gel filling station (FIGS. 4A-4C), generally identified with the reference numeral 22, may be provided. Various antibacterial gels are suitable for use. Preferably, the antibacterial gel is a rub on fast drying alcohol gel, such as Purell hand sanitizer, as manufactured by Gojo Industries, Inc. of Akron, Ohio.

The antibacterial gel filling station 22 may be configured for either wall or table mounting and is used for filling the antibacterial gel dispenser 20 (FIGS. 1A-1I) as well as the antibacterial gel reservoir of the combination antibacterial gel and towelette dispenser (FIGS. 3A-3D), generally identified with the reference numeral 24. By appropriately locating the antibacterial filling station 24 in the environment, healthcare personnel are further exposed to the need for hand sanitation, while also facilitating the use of the antibacterial gel dispenser 20, thus further promoting behavior modification with respect to hand sanitation.

Iconography is another behavior modification mechanism that may be used to promote sanitation. In particular, the iconography (FIG. 5), generally identified with the reference numeral 26, may be configured in a manner that is easily identifiable with different aspects of hand sanitation. Three exemplary icons are illustrated in FIG. 5 and generally identified with the reference numerals 28, 30 and 32. These icons 28, 30 and 32 may be configured to promote different aspects of sanitation. For example, the icon 28 may be used to promote environmental sanitation. The icon 30 may be used to promote proper medical device sanitation, while the icon 32 may be used to promote proper hand washing behavior. The icons 28, 30 and 32 may be strategically located in the work place environment to remind healthcare and other personnel, and thus function as a behavior modification mechanism, to observe proper sanitation techniques. Indeed, healthcare and other personnel will be encouraged by the icons 28, 30 and 32 of proper hand washing, proper medical device sanitation, and proper environment sanitation techniques. This iconography 26 may be used in conjunction with the other behavior modification mechanisms to reinforce all aspects of proper sanitation techniques.

The efficacy of behavior modification techniques depends, at least partly upon the nature of the behavior to be taught, but may also depend upon or be dictated by a variety of other considerations, including, for example, location, access, visibility, ease-of-use to healthcare personnel. As such, devices configured as behavior modification mechanisms may be formed with antibacterial plastic surfaces, such as, plastics formed with silver ion compounds, thus reducing the risk of the healthcare personnel transferring germs from patients. Such silver ion compounds are commonly available, under the trade name IONPURE, available from Ishizuka Glass Co. Ltd. (http:/www.marubeni-sunnyvale.com/trading_partners_ishizuka.html). Such compounds are known to deprive bacteria of moisture, thus preventing growth of the bacteria.

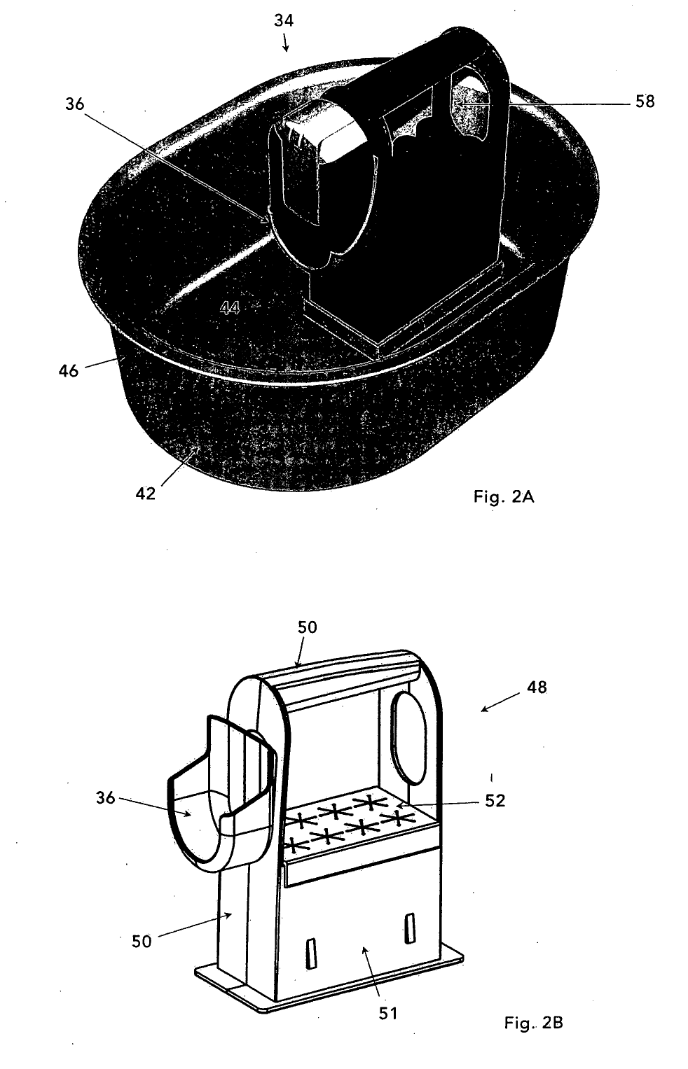

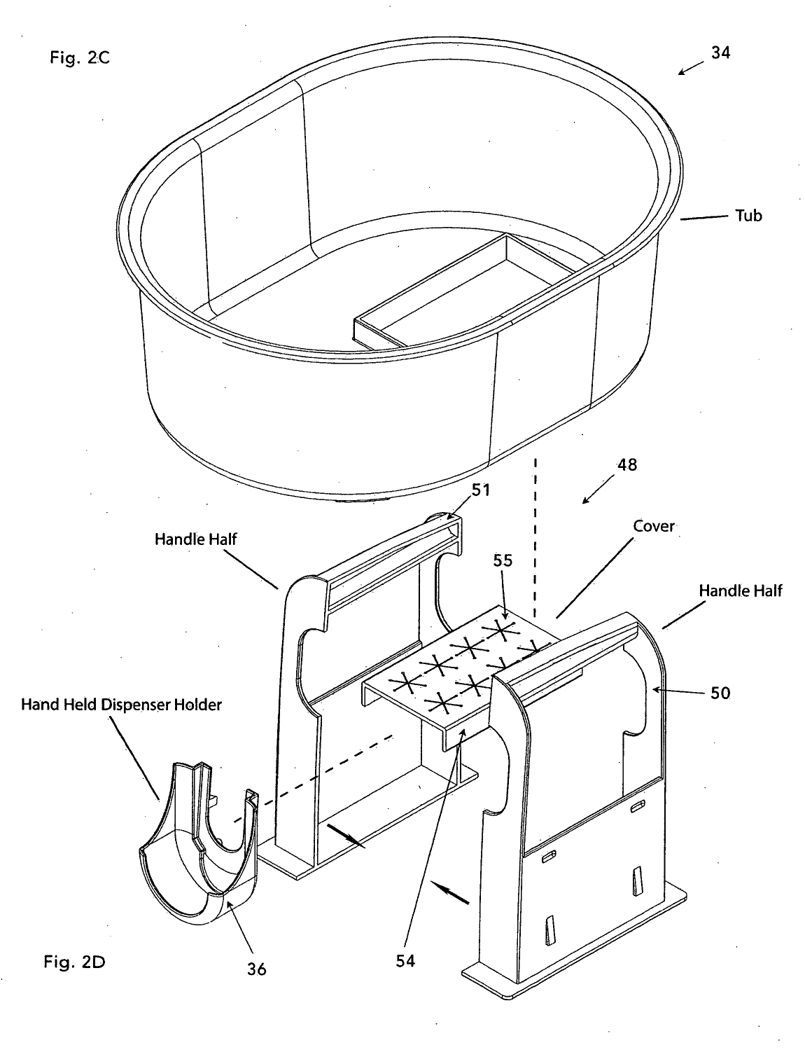

Applications exist in the healthcare environment where the target work environment overlaps multiple facilities. For example, a healthcare professional that takes blood and cultures from different patients in a clinical environment transports those cultures and blood to the medical laboratory—another environment. In order to promote proper sanitation in such overlapping environments, a behavior modification mechanism configured as a medical caddy 34 (FIGS. 2A and 2B) is provided. The medical caddy 44 may be formed from antibacterial plastic as discussed above and may be configured with a holder 36 for carrying an antibacterial gel dispenser 20 (FIGS. 1A-1I). With such a configuration, the material used prevents the medical caddy 34 from transferring germs, while the portable antibacterial gel dispenser carried by the medical caddy 34 encourages healthcare personnel to practice proper hand sanitation techniques in environments that overlap multiple facilities to minimize the spread of germs in such environments.

In many industries, various food items, both unprepared and pre-prepared, are known to be sealed with plastic wrap. In many instances, the same utensil is known to be used for multiple food items to puncture the plastic wrap before heating. If that utensil becomes contaminated, for example, from one of the food items, the risk is fairly high that those germs will be transferred to other food items. FIGS. 6A-6C illustrate a behavior modification mechanism configured as a device that reduces that risk by providing a device that can safely be used to puncture holes in plastic wrap used to seal various foods, both unprepared and pre-prepared foods. The puncture device, generally identified with the reference numeral 38, is used to modify known behavior of using the forks, knives and other utensils to puncture the plastic wrap. Indeed, the puncture device 38 includes a number of a prongs 40 made from antibacterial material, for example, as discussed above.

### DETAILED DESCRIPTION OF DEVICES

1. Antibacterial Gel Dispenser

The antibacterial gel dispenser 20 is illustrated in FIGS. 1A-1I. An important aspect of the portable antibacterial gel dispenser is that it is configured with a belt clip 61 (FIGS. 1H and 1I) to encourage healthcare or other personnel to carry the portable antibacterial gel dispenser 20 while performing their duties. As show best in FIG. 1D, the portable antibacterial gel dispenser 20 includes a container 70 and a nozzle assembly, generally identified with the reference numeral 63, which cooperates with a dispensing pump 72 to dispense antibacterial gel. The nozzle assembly 63 may include a slide button 60, a nozzle stem 88, an extended nozzle 92, a torsion spring 96 and a slide button 60. The torsion spring 96 is formed with a pair of spaced apart legs 95 and 97, connected by a bight portion 99. As shown best in FIGS. 1G and 1H, the extending legs 95 and 97 are captured by a pair of spaced apart bosses, generally identified with the reference numeral 101, integrally formed on the extended nozzle 62. When the slide button 60 is pushed downwardly, the underside of the slide button 60 engages the bight portion 99 of the torsion spring 96. Continued downward movement of the slide button 60 causes the torsion spring 96 to compress, thereby causing the extended nozzle 92 to rotate to a dispense position as shown in FIG. 1F. As shown in FIG. 1G, continued downward pressure on the slider button 60 actuates a liquid dispenser pump 66, disposed within an aperture 68 in a container 70, which causes liquid to be dispensed. The liquid dispensing pump 66 may be a conventional liquid dispensing pump, for example, a part # DP102, as manufactured by the Living Fountain Plastic Industrial Co. Ltd. of Taichung, Taiwan R.O.C. When downward pressure on the slider button 60 is released, the nozzle stem 90, extended nozzle, 92 and the slider button 60 stem return to a normal position as shown in FIG 1E.

As mentioned above, the nozzle assembly 63 may include a nozzle stem 88, an extended nozzle 92, a torsion spring 96 and a slider button 60. The nozzle stem 88 fits over the stem 72 of the liquid dispensing pump 66. More particularly, the nozzle stem 88 may be formed with a globe or ball portion 90. The extended nozzle 92 is formed as a socket, sized to capture the ball portion 90 of the nozzle stem 88 forming a ball and socket arrangement. In such a ball and socket arrangement, the extended nozzle 92 is free rotate. As discussed above, downward movement of the slider button 60 compresses the torsion spring 96 and causes the extended nozzle 92 to rotate is causing the extended nozzle 92 to protrude through the aperture 64 in the slider button 60, as shown in FIG. 1C.

The slider switch 60 is formed in a generally rectangular shape and sized to fit within a rectangular cavity 98 formed in the container 70. As best shown in FIG 1D, the container 70 may be formed with a pair of spaced apart vertical tracks 98 and 100. These vertical tracks 98 and 100 are configured to receive a pair of spaced apart ribs 102, formed in opposing sidewalls 104 of the slider button 60 to guide the movement of the slider button 60. After the slider button 60 is received in the tracks, the pair of tabs 106 and 108 may be used to close the tracks 98 and 100, thereby acting as an upper stop limiting upward travel of the slider button 60.

As shown in FIG 1D, the container 70 may be an irregular shape container having a generally U shape. A pair of internal walls, designated by the lines 74 and 76 close the container such that its only openings are a pump aperture 68 and a refill aperture (not shown) on the backside. A refill plug 78 may be used to removably close the refill aperture in order to allow refilling of the portable antibacterial gel dispenser 20. The refill plug 78 may be formed as a two piece plug having a first member 80 configured to be disposed within the container 70 attached to a exterior piece 82 by way of a strap 84. The exterior piece 82 may include a plug portion 86 and a cap portion 88, which allows the plug portion 82 to be easily grabbed and removed from the refill aperture. By strapping the external member 82 to an internal member 80, the risk of loss of the refill plug 78 is virtually non-existent.

In accordance with other features of the invention, the container 70 may be formed from a clear material so that the gel level within the container 70 is always visible. In accordance with another important feature of the invention, the materials used for the portable antibacterial gel dispenser may be formed from an antibacterial material, as discussed above, thereby minimizing transfer of any bacteria.

2. Medical Caddy

The medical caddy 34 is illustrated in FIGS. 2A-2D. The medical caddy 34 is formed as an open top container 42, formed, for example, in an oval shape defining a floor 44 and a continuous sidewall 46. The container 42 may be formed from various materials including an antibacterial plastic material, as discussed above, and may be formed by various well known molding techniques, such as injection molding. As best shown in FIG. 2B, an exemplary handle assembly 48 may be provided. In accordance with an important aspect of the invention, a holder 36 for an antibacterial gel dispenser 20 (FIGS. 1A-1I) may be integrally formed with the medical caddy 34. As shown, the holder 36 may be formed as part of the handle assembly 48 but alternatively may be carried by other portions of the medical caddy 34. As shown in FIG. 2D, the medical caddy 34 may include a handle assembly 48, formed from a pair of handle halves 50 and 51 (FIG. 2D).The handle halves 50 and 51 are attached together as shown in FIG. 2B. A cover 54 may be provided to form a generally rectangular carrier with a plurality of slits, generally identified with the reference numeral 55, for securely carrying vials 58 (FIG. 2A) of blood and the like.

The handle assembly 48 may be formed in the same manner and from the same materials as the open top container 42. The handle assembly 48 may be attached to the floor 44 of the open top container 42 by various well known methods including ultrasonic welding or laser welding and with various adhesives.

3. Combination Antibacterial Gel and Towelette Dispenser

The combination antibacterial gel and towelette dispenser 24 is illustrated in FIGS. 3A-3C. As best shown in FIG. 3C, the antibacterial gel and towelette dispenser may include a generally oval shaped housing 110. One portion of the housing 110 may be used for dispensing of antibacterial gel, while another portion of the housing may be used for dispensing antibacterial towelettes. More specifically, the housing 110 may include a liquid container portion 112 and a towelette container portion 114. As shown, an access aperture 118 is provided that is adapted to be closed by a door 120 for refilling antibacterial gel into the gel container portion 112. The gel container portion 112 is in fluid communication with a gel dispenser 120, and is provided in a generally oval shaped aperture 122. The antibacterial gel dispenser 120 operates in the same manner as discussed above.

As best shown in FIG. 3D, the towelette container portion 114 includes a dispensing aperture 124. An access door 126 is provided which removably closes an opening 127 in the towelette portion 114 to enable the towelettes to be refilled. The towelettes, generally identified with the reference numeral 129, may be, for example 2″×2.25″ square. A cover 128 (FIG. 3C) may be provided to cover an index aperture 130 which may be provided to facilitate removal of the packet door 126.

The entire assembly may be covered with a form fit front cover 132 and disposed on a base front 134. A base back 136 is securely attached to the base front 134 in order to provide the capability for wall mounting. A bracket 138 may be provided which mounts on the wall and is configured to secure the base back 136 thereto.

4. Antibacterial Gel Filling Station

The antibacterial gel filling station 22 is illustrated in FIGS. 4A-4C and may be wall mounted by a wall mount bracket 175 (FIG. 4C). The filling station 22 may be formed with an irregular shape container 150 which includes a pump access aperture 152 and a refill aperture 154. The pump access aperture 152 is adapted to receive a conventional liquid dispenser pump 156. The liquid dispenser pump 156 may be a conventional pump for example a part # FND30, as manufactured by Rieke Dispensing of Auburn, Ind. Such pumps are normally spring biased and include a dispensing nozzle 158 and a button 160. In operation, downward movement of the button 160 causes liquids within the container 150 to be dispensed from the dispensing nozzle 158. When downward pressure or force is released from the button 160, the liquid dispensing pump 160 is configured to spring return back to a normal position as generally shown in FIG. 4D. A top cover 165 is configured to cover a dispensing portion 167 of a front cover 169 as well as a portion of the container 150. The top cover 165 is formed with a generally u-shaped notch 171 to allow a stem portion 173 of the liquid displacement pump 156 to protrude therethrough.

The container 150 is closed on one end by a tab 161. The other end of the container is closed partially by a tab panel 163 defining a relatively wide mouth refill aperture 154. The refill aperture 154 is removably closed by a refill door 155.

5. Puncture Device

The puncture device 38 is illustrated in FIGS. 6A-6C. The puncture device 38 includes a bottom housing 170 and a top housing 172. The top housing 172 is provided with a pair of spaced apart standoffs 174 and 176. These standoffs 174 and 176 may be formed with threaded apertures for receiving a pair of fasteners 178 and 180. The standoffs 174 and 176 are adapted to be received in a pair of aligned aperture 182 and 184 in the base housing 170. As shown, the base housing 170 is provided with a number of spaced apart apertures, generally identified with the reference numeral 86. These apertures 86 are configured to receive a number of spikes, generally identified with the reference number 188 carried by a spring board 190. The spikes 188 are used to puncture plastic wrap used to seal a food item.

A pair of spaced apart apertures 192 and 194 is formed in the spring board. 190. These apertures 192 and 194 are configured to receive the standoffs 174 and 176. As such, when the top housing 172 is secured to the base housing 170, the spring board 190 will be captured therebetween. The spikes 188 are configured to be aligned with the apertures 186 when the spike board 190 is captured between the top housing 172 and the base housing 170.

The spring board 190 includes a pair of spaced apart leaf springs 196 and 198. These leaf springs 196 and 198 are configured with a curvature so that in a normal position the spikes 188 do not protrude through the apertures 186. A pair of pushbuttons 200 and 202 is provided to enable leaf springs 196 and 198 to be compressed, thus forcing the spring board 190 and thus the spikes 188 downwardly when the pushbuttons 200 and 202 are pushed towards each other. As shown, the pushbuttons 200 and 202 each include a pair of U-shaped slots 204, 206. These slots 204 and 206 are aligned so that the standoffs 174 and 176 do not prevent the pushbuttons 200 and 202 from being pushed together.

The push buttons 200 and 202 are provided with wedges 208 and 210 which push downwardly on the leaf springs 196 and 198 when the push buttons 200 and 202 are pushed together, thus forcing the spring board 190 downwardly, as discussed above. When inward force is released from the push buttons 200 and 202, the biasing force of the leaf springs 196 and 198 pushes against the wedges 208 and 210 forcing the push buttons 200 and 202 away from each other, thus causing the spikes 188 to retract. Stops, generally identified with the reference number 212, may be formed on the interior of the sidewalls 214, 216 of the base housing 170 to limit movement of the push buttons 200 and 202.

Obviously, many modifications of the present invention are possible in light of the above teachings. For example, devices identified as antibacterial gel dispensers may be substituted with antibacterial towelette dispensers or combinations of the two. Conversely, devices identified as combination antibacterial gel and towelette dispensers may be substituted with dispensers for dispensing one or the other. Thus, it is to be understood that, within the scope of the appended claims, the invention may be practiced otherwise than is specifically described above.

What is claimed and desired to be secured by a letters patent of the united states is:

1. A method of modifying behavior of personnel with respect to sanitation techniques comprising the steps of:
a.) selecting an environment in which behavior modification with respect to sanitation is desired; and
b.) providing one or more behavior modification mechanisms configured to modify behavior with respect to sanitation in the selected environment.

2. The method as recited in claim 1, wherein step a.) comprises selecting a healthcare environment..

3. The method as recited in claim 1, wherein step a.) comprises selecting a non-healthcare environment..

4. The method as recited in claim 1, wherein step a.) comprises selecting an environment which overlaps multiple facilities.

5. The method as recited in claim 3, wherein step a.) comprises selecting an environment in the food industry.

6. The method as recited in claim 1, wherein step b.) comprises providing an antibacterial gel dispenser.

7. The method as recited in claim 6, wherein step b.) comprises providing a portable antibacterial gel dispenser.

8. The method as recited in claim 6, wherein step b.) comprises providing a wall mounted anti bacterial dispenser.

9. The method as recited in claim 1, wherein step b.) comprises providing a antibacterial towelette dispenser.

10. The method as recited in claim 1, wherein step b.) comprises providing a combination antibacterial gel and towelette dispenser.

11. The method as recited in claim 6, further including a step c.) providing a filling station for filling said antibacterial gel dispenser.

12. The method as recited in claim 4, wherein step b.) comprises: providing a medical caddy formed from antibacterial material.

13. The method as recited in claim 12, wherein step b.) comprises providing a medical caddy which carries an antibacterial gel dispenser.

14. The method as recited in claim 1, wherein step b.) comprises: providing a device for safely puncturing plastic wrap used to seal food.

15. The method as recited in claim 1, wherein step b) includes a further step of providing iconography configured to promote sanitation.

16. The method as recited in claim 3, wherein step a.) comprises selecting an environment in the cosmetic industry.

17. The method as recited in claim 3, wherein step a.) comprises selecting an environment in the retail industry.
